(19) United States
(12) Patent Application Publication
(10) Pub. No.: US 2017/0140475 A1
(43) Pub. Date: May 18, 2017

(54) SYSTEM AND METHOD FOR ASSISTING IN MAKING LIFE DECISIONS BASED ON ZODIAC INFORMATION

(71) Applicant: Zodiac Heartology, LLC, Unionville, PA (US)

(72) Inventors: Stephanie Brown, Wayne, PA (US); Geoffrey Towell, West Chester, PA (US); John Angelone, Weston, FL (US); Martin Folks, West Chester, PA (US)

(73) Assignee: Zodiac Heartology, LLC, Unionville, PA (US)

(21) Appl. No.: 15/323,408

(22) PCT Filed: Jun. 30, 2015
(86) PCT No.: PCT/US2015/038405

§ 371 Date: Dec. 31, 2016

Related U.S. Application Data
(60) Provisional application No. 62/019,509, filed on Jul. 1, 2014.

(51) Int. Cl. G06Q 50/00; G09B 19/00; G06F 17/30

(52) U.S. Cl. CPC G06Q 50/01; G06F 17/30867; G09B 19/00

(57) ABSTRACT

In described embodiments, the present invention is a system and method for assisting a user to determine lifestyle choices based on zodiac information.

### CROSS-REFERENCE TO RELATED APPLICATION

The present application claims priority from U.S. Provisional Patent Application Ser. No. 62/019,509, filed Jul. 1, 2014, which is incorporated herein by reference in its entirety.

### BACKGROUND OF THE INVENTION

Field of the Invention

The present invention relates to a system and method for providing life decision recommendations to people based on numerous zodiacs, and, in particular, to comparing traits of friends, acquaintances and business associates with those of subscriber user as well as determining potential romantic matches for people based on numerous zodiacs.

Description of the Related Art

Zodiacs are often used to help people, determining what is going on in their lives and helping them make decisions concerning their lives. Zodiacs are also used to help people determine qualities and traits in themselves and others. Numerous zodiacs are used in different ways, although all zodiacs are generally related to the movement of celestial bodies. It would be beneficial to provide a single location that combines the qualities and features of several zodiacs to assist people in making life decisions.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a method for matching people. The method comprises receiving electronic input from a first party, the input including the first party's birthdate; determining characteristic traits of the first party based on the first party's birthdate; searching an electronic database to determine a plurality of compatible second parties based on the characteristic traits of the first party and characteristic traits of each of the plurality of second parties based on each of the second party's birthdates; and electronically displaying information about the plurality of second parties to the first party.

In another embodiment, the present invention is a non-transitory machine-readable storage medium, having encoded thereon program code, wherein, when the program code is executed by a machine, the machine implements the method for matching people described above.

In another exemplary embodiment, the present invention is an electronic method for matching people. The method comprises receiving electronic input from a first party, the input including the birth date of the first party; determining the Chinese and Western zodiac information about the first party; determining a first party profile for the first party based on the Chinese and Western zodiac information; determining compatible profiles for the first party based on the first party profile; determining a combination of compatible Chinese and Western zodiacs that fit the compatible profiles; and providing the compatible Chinese and Western zodiacs to the first party.

In still another exemplary embodiment, the present invention provides an electronic method for anticipating how an athlete will perform in an athletic competition. The method comprises determining the athlete's event date and local time (which can be provided as the closest hour for when the event starts); determining the athlete's birth date; electronically inputting the athlete's event date and birth date into a processor; and using a database incorporating a zodiac to compare the athlete's event date and birth date to categorize how the athlete is expected to perform on the event date within one of a plurality of performance categories.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram showing the general operational structure of an electronic system in accordance with a first exemplary embodiment of the present invention;

FIGS. 1A and 1B are exemplary screenshots of a homepage using the system of the present invention;

FIGS. 2A and 2B are exemplary screenshots of a Western horoscope page using the system of the present invention;

FIGS. 3A and 3B are exemplary screenshots of a Chinese horoscope page using the system of the present invention;

FIGS. 4A and 4B are exemplary screenshots of destiny card information using the system of the present invention;

FIG. 5 is an exemplary screenshot showing the entry of a birthdate to obtain a Chinese zodiac sign;

FIG. 6 is an exemplary screenshot showing the entry of a birthdate to obtain a Western zodiac sign;

FIG. 7 is an exemplary screenshot showing the entry of a birthdate to obtain a Western Zodiac sign;

FIG. 8 is an exemplary screenshot showing the entry of the birthdate to obtain a Daymaster;

FIG. 9 is an exemplary screenshot showing the entry of the birthdate to obtain a destiny card;

FIG. 10 is an exemplary screenshot showing the generation of a destiny card based on the entry of a birthdate;

FIG. 11 is exemplary screenshot showing information about the destiny card shown FIG. 10;

FIG. 12 is an exemplary screenshot showing a registration page to register for the system according to the present invention;

FIG. 13 is an exemplary screenshot showing a home page after a user completes registration or logs in;

FIG. 14 is a flowchart showing a first exemplary use of the system according to the present invention;

FIG. 14A is a chart showing birth cards related to dates in a calendar year;

FIG. 15 is a flowchart showing a second exemplary use of the system according to the present invention;

FIG. 16 is a flowchart showing a third exemplary use of the system according to the present invention;

FIG. 17 is a flowchart showing the use of an event analyzer according to an exemplary embodiment of the present invention;

FIG. 18 is an exemplary screenshot showing the input of an event in which selected athletes cooperate with each other according to the system of the present invention;

FIG. 19 is an exemplary screenshot showing the input of participant information in the event shown in FIG. 18;

FIG. 20 is exemplary screenshot showing the calculation of an athlete's event score for the event shown in FIG. 18;

FIGS. 21 and 21A are exemplary screenshots showing the calculation of all selected athletes' event scores for the event shown FIG. 18;

FIGS. 22 and 22A are exemplary screenshots showing the input of an event in which selected athletes compete against each other according to the system of the present invention;

FIG. 23 is an exemplary screenshot of a BaZi Compatibility Calculator input page for use with the system of the present invention; and

FIG. 24 is a chart showing the results of the exemplary calculations using the compatibility calculator shown in FIG. 23.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Referring to the figures in general, a system 50 and method for matching people based on zodiac information is disclosed. Zodiac information includes information about a person's birth date, a date subsequent to the person's birthdate, such as, for example, today's date, or a date in the future, such as an upcoming wedding date, the date of a sporting event, or other important date.

For thousands of years, numerous cultures have used zodiacs to interpret life events. Some exemplary zodiacs include the Chinese Zodiac, Western Zodiac, African Zodiac, Babylonian Zodiac, Indian Zodiac, Mayan Zodiac, Aztec Zodiac, as well as other. Each zodiac is interpreted in different ways. However, it is believed that each zodiac may play at least a small part in determining or predicting a person's life experiences.

Referring specifically to the Chinese zodiac, in addition to the 12 animal signs that each represent a separate lunar year throughout the Chinese calendar, other influences the come into play are the five elements (water, fire, earth, metal and wood), and the Yin/Yang duality. Each animal sign has its own personality characteristics.

The element signs form separate creative and destructive cycles. For example, in the creative cycle, water creates wood because water is necessary for plants to grow; wood creates fire, because fire needs wood to burn; fire creates earth in the form of the ashes that are created in the burning; earth creates metal because metal is mine from the earth; and metal creates water because water condenses on metal. In the destructive cycle, water destroys fire, fire destroys metal, metal destroys wood, wood destroys earth, and earth destroys water. Additionally, wood exhausts water, water exhausts metal, metal exhausts earth, earth exhausts fire, and fire exhausts wood. Each element is associated with two adjacent years such that, years ending in the numerals 0 or 1 are associated with metal; years ending in the numerals 2 or 3 are associated with water; years ending in the numerals 4 or 5 are associated with wood; years ending in the numerals 6 or 7 are associated with fire; and years ending in the numerals 8 or 9 are associated with earth.

Chinese astrology uses 60 year cycle that is combination of the 12 animal and the five element cycles. However, the Yin and Yang aspects of each element are used, resulting in a cycle of 10 phases, which are: Yang wood, Yin wood, Yang fire, Yin fire, Yang Earth, Yin earth, Yang metal, Yin metal, Yang water, and Yin water. Each even numbered year is associated with Yin, while each odd-numbered year is associated with Yang.

In the Chinese zodiac, certain animals are compatible other animals, while other animals are incompatible with those animals. The present system takes into account compatibility and incompatibility of the animals. For example, oxen tend to be most compatible with roosters and snakes, while oxen tend to be least compatible with horses, sheep and tigers.

Additionally, some animal relationships are very destructive in nature. A destructive relationship occurs when certain animals are next to other animals in Bazi pillars. For example, a rat is destructive to a rooster; a monkey is destructive to a snake; a dragon is destructive to an ox; a horse is destructive to a rabbit; a tiger is destructive to a pig; and a dog is destructive to a goat.

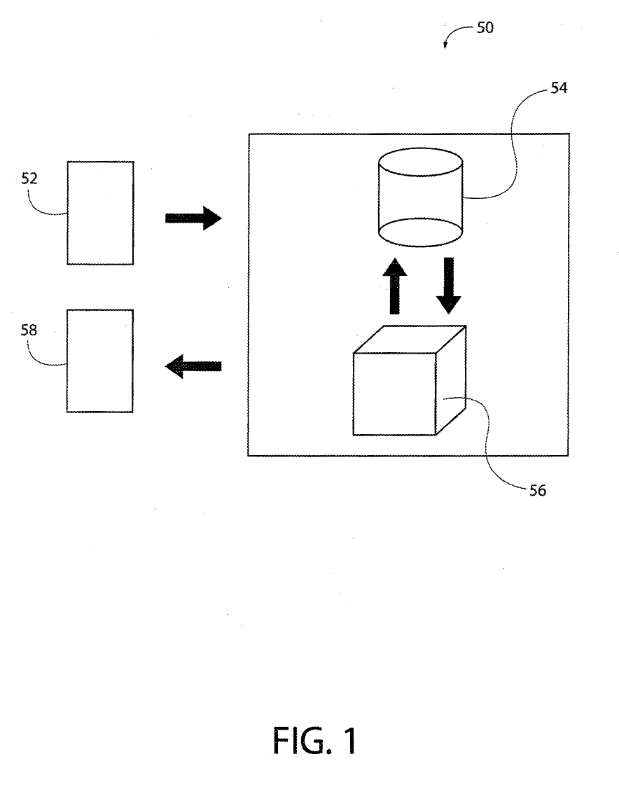

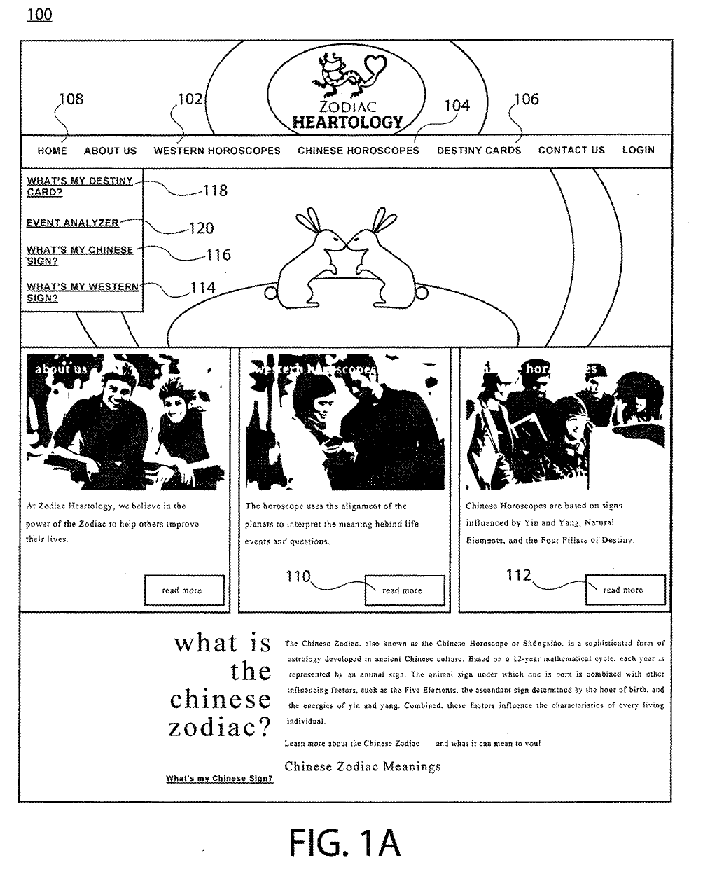

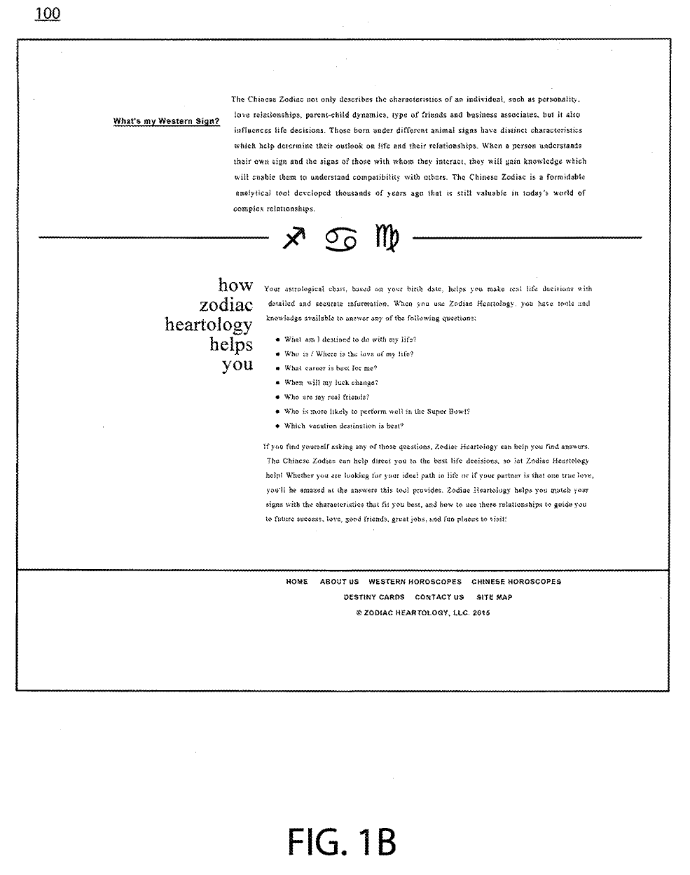

As shown in FIG. 1, system 50 includes a receiving interface 52 adapted to receive personal information from a first party. In order to use the zodiac matching and analysis information used by system 100, the personal information must include a first birthdate. System 50 further includes a database 54, which includes characteristic traits of people for all birthdates contained within system 50. The characteristic traits can include at least one trait selected from the group consisting of: employment and leisure activities. In an exemplary embodiment of the present invention, a processor 56 is configured to determine characteristic traits of other parties that are compatible with the characteristic traits of people having the first birthdate. A transmitting interface 58 is adapted to transmit information about the other parties to the first party.

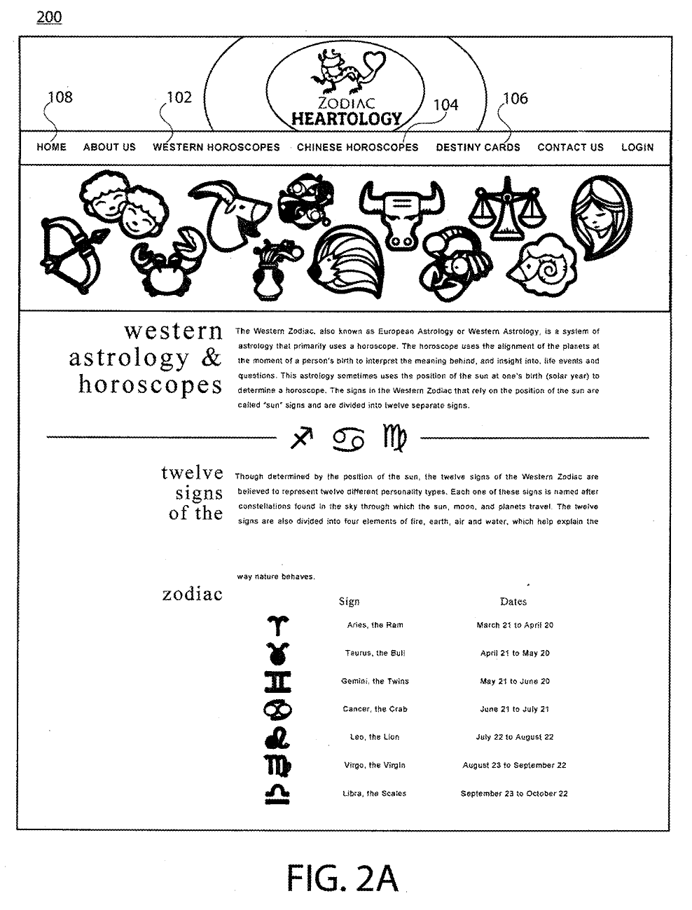

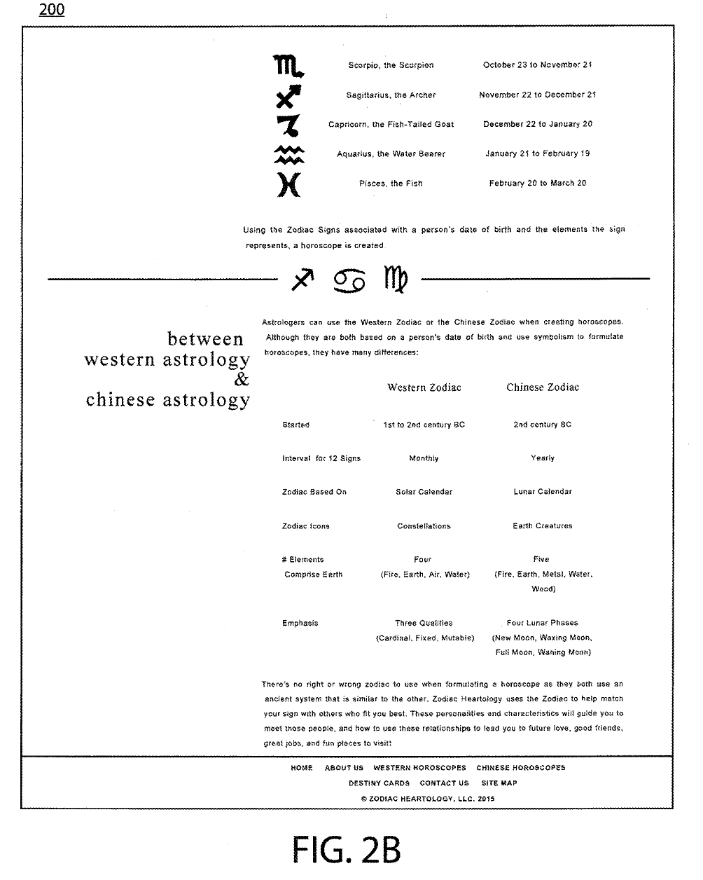

To use the inventive system 50, a user accesses system 50 using GUI 100, shown in FIGS. 1A and 1B. An unregistered user can click on various buttons to learn some information about the different zodiacs. For example, the user can click on “Western Horoscopes” button 102 and generate GUI 200, shown FIGS. 2A and 2B. GUI 200 provides information about the Western horoscope and lists the 12 Western zodiac signs, along with the time periods throughout the year associated with each zodiac sign. Additionally, FIG. 2B provides a comparison between the Western zodiac in the Chinese zodiac.

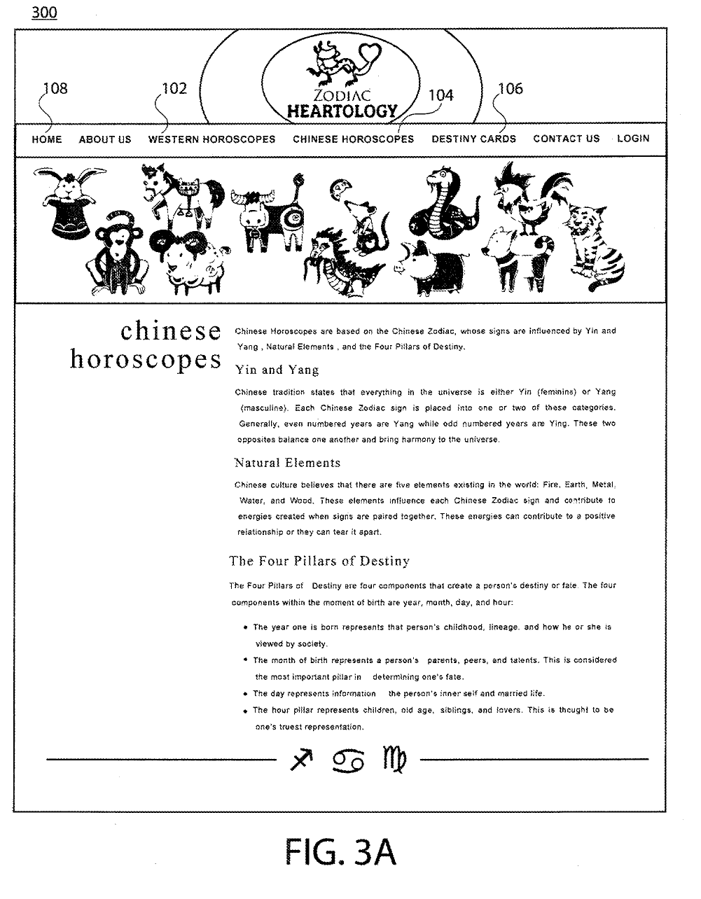

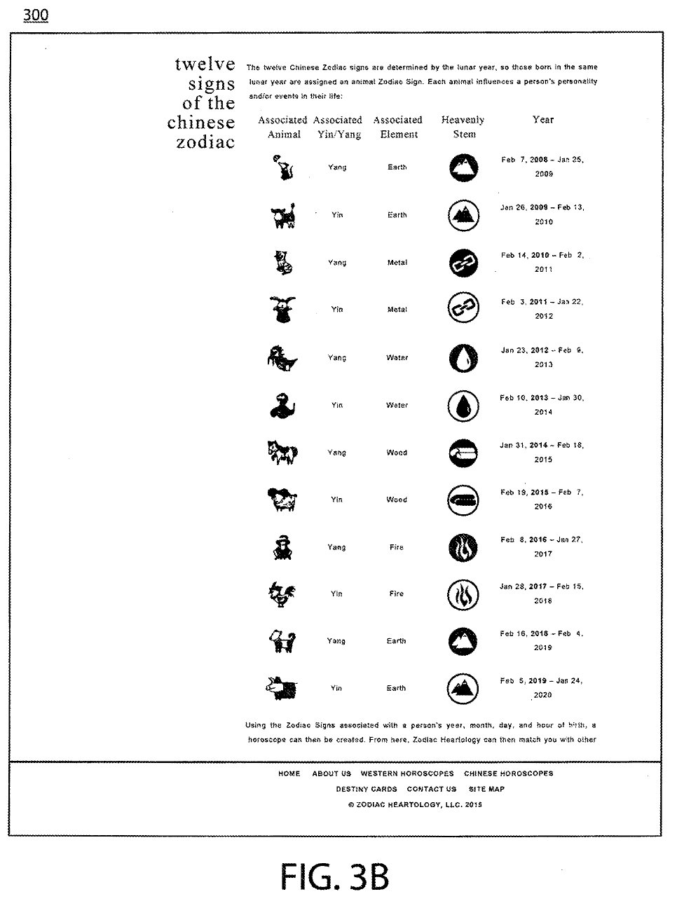

Similarly, the user can click on “Chinese Horoscopes” button 104 and generate GUI 300, shown in FIGS. 3A and 3B. GUI 300 provides information about the Chinese horoscope, including Yin/Yang; natural elements of fire, earth, metal, water, and wood; and the Four Pillars of Destiny, which represent the person's birth year, birth month, birthday, and birth hour. Additionally, GUI 300 displays the 12 animal signs of the Chinese zodiac and their associated time frame, which is approximately a calendar year.

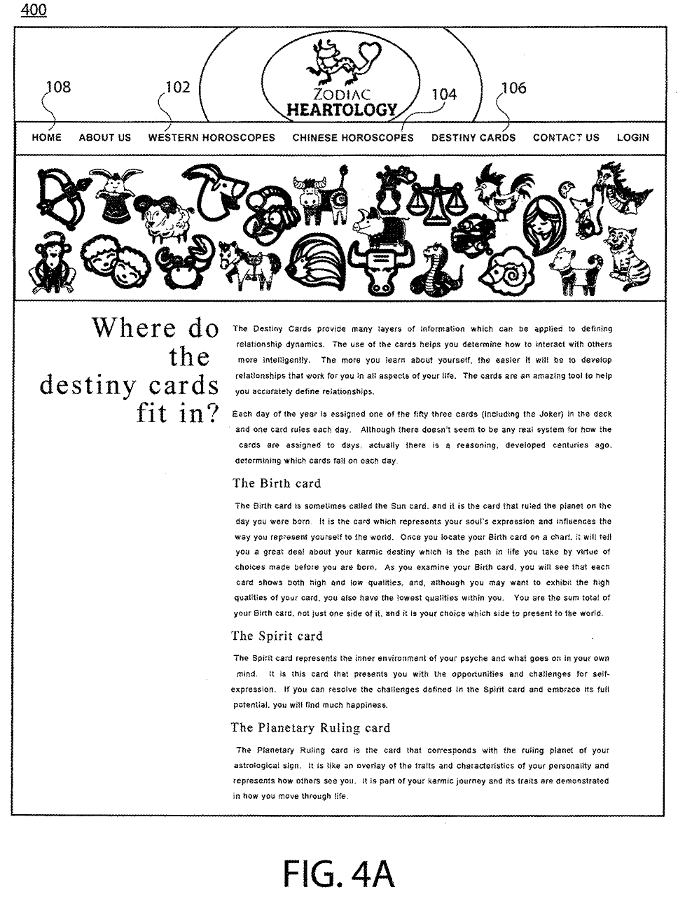

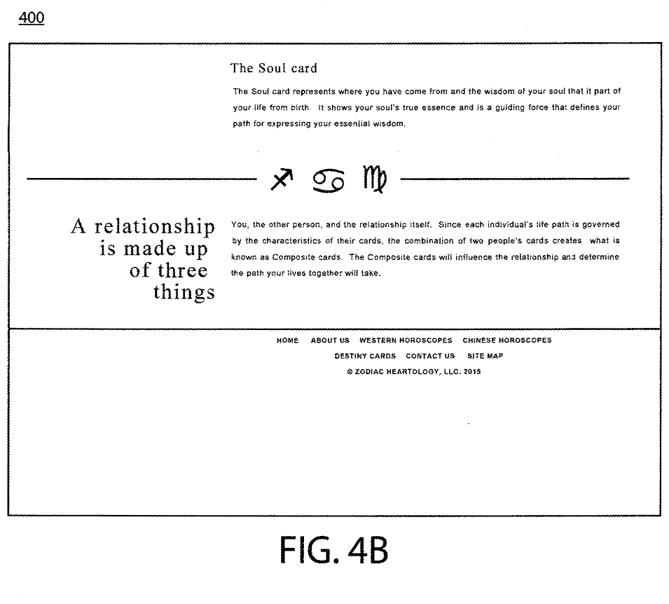

Additionally, the user can click on “Love Cards” 106 and generate GUI 400, shown in FIGS. 4A and 4B. GUI 400 described cell “Love” or “Destiny” cards are used in defining relationship dynamics. The Destiny Cards include the Birth card, the Spirit card, the Planetary Ruling card, and the Soul card. Each card includes a description of the card and how the cards represent different aspects of a user's personality and life.

From any of GUI 200, 300, 400, the user can click on a “Home” button 108 to return to GUI 100. Instead of clicking on button 102, the user can click on the “read more” icon 110 to generate GUI 200 and, instead of clicking on button 104, the user can click on the “read more” icon 112 to generate GUI 300. Additionally, GUI 100 provides information regarding the Chinese zodiac and now the inventive system 50 can help the user.

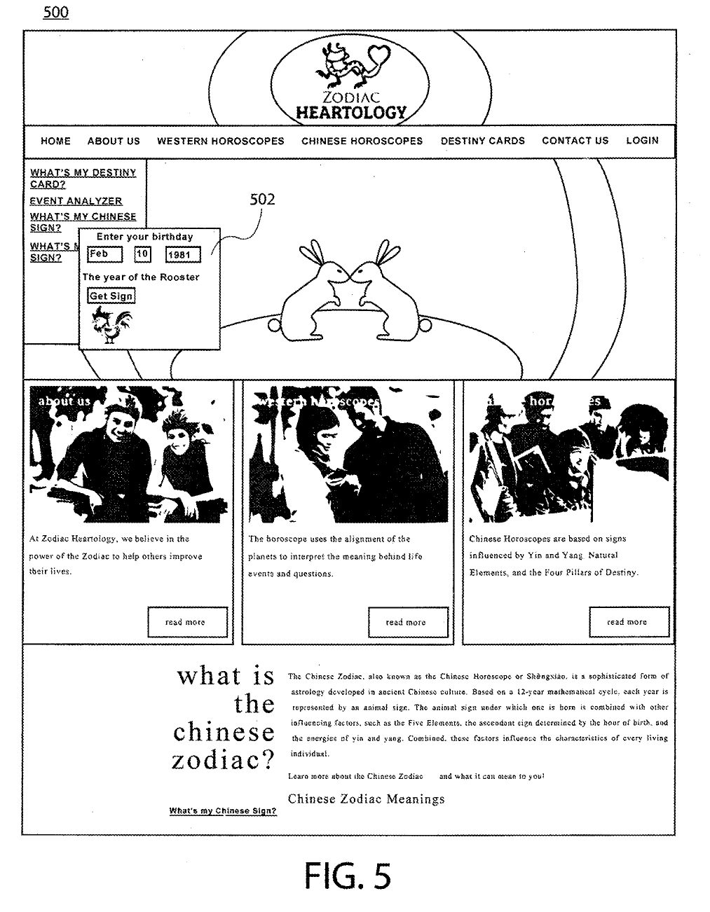

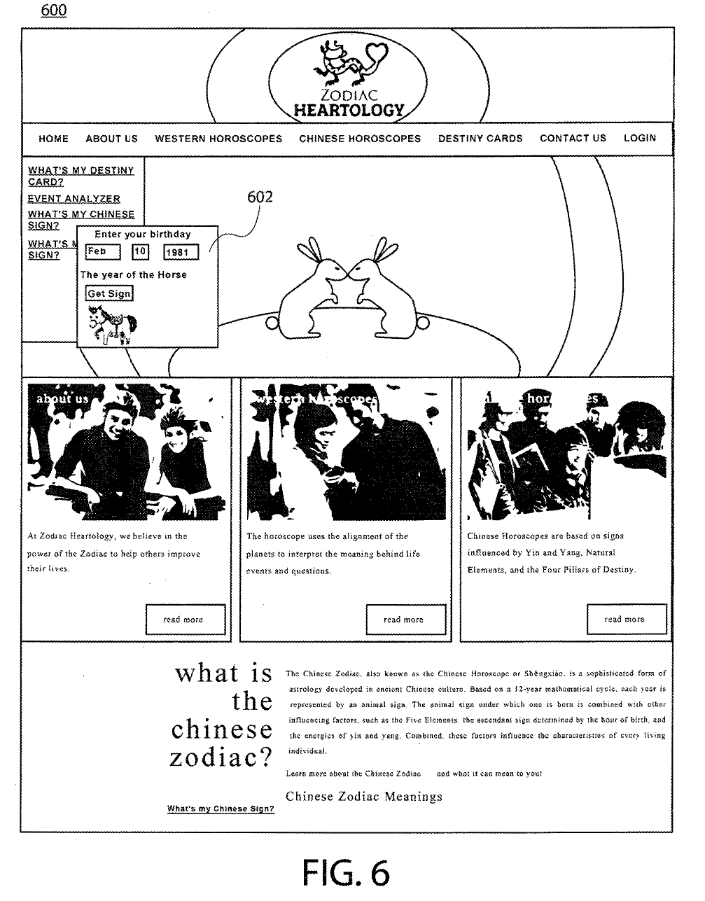

From GUI 100, user can click on “What's my Chinese sign?” 114 and generate GUI 500 shown in FIG. 5, which generates a drop-down menu that allows the user to input his birth month, day, and year and click on button “Get Sign” 502 to generate GUI 600, shown in FIG. 6. In this particular instance, for the birthdate Jan. 1, 2014, the user's year, is displayed in text 602 as that of the horse.

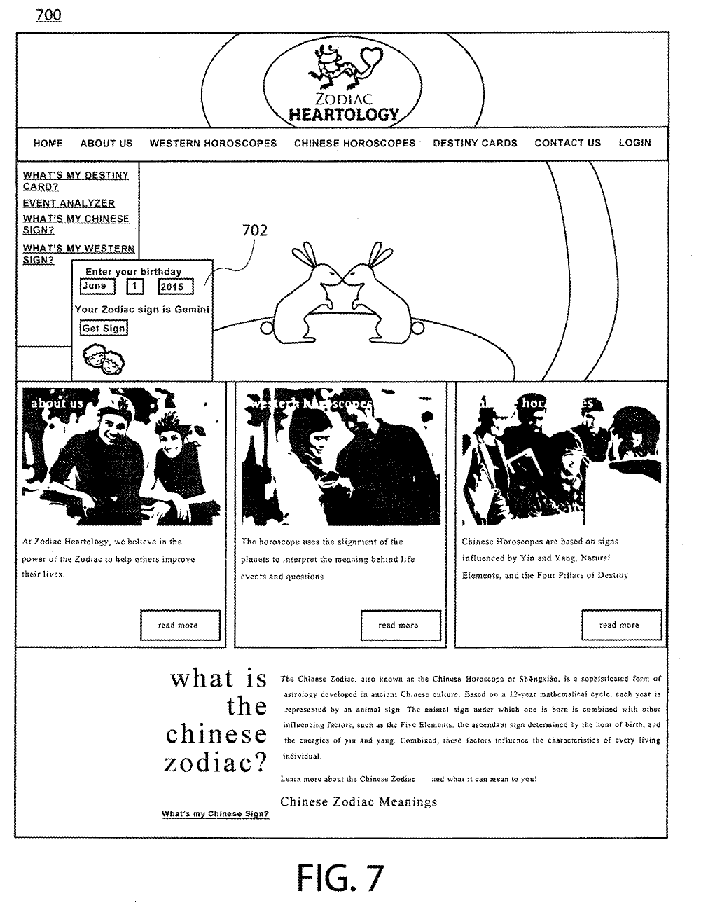

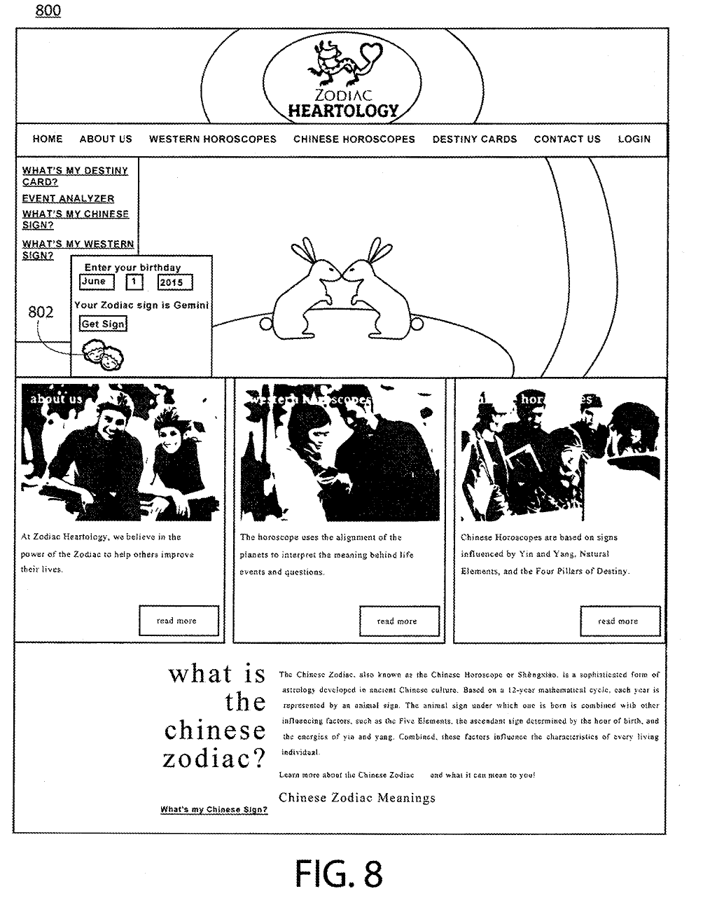

Similarly, from GUI 100, user can click on “What's my Western sign” 116 and generate GUI 700 shown FIG. 7, which generates a drop-down menu that allows the user to input his birth month, day, and year and click on button “Get Sign” 702 to generate GUI 800, shown FIG. 8. In this particular instance, for the birthdate Jan. 1, 2014, the user's sign, is displayed in text 802 as that of Capricorn.

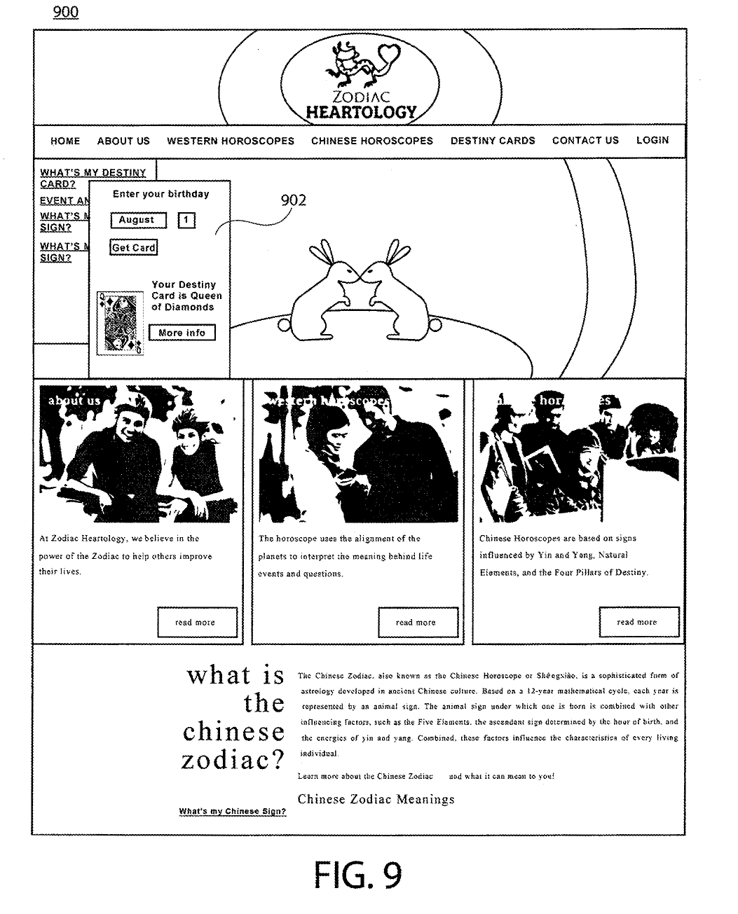

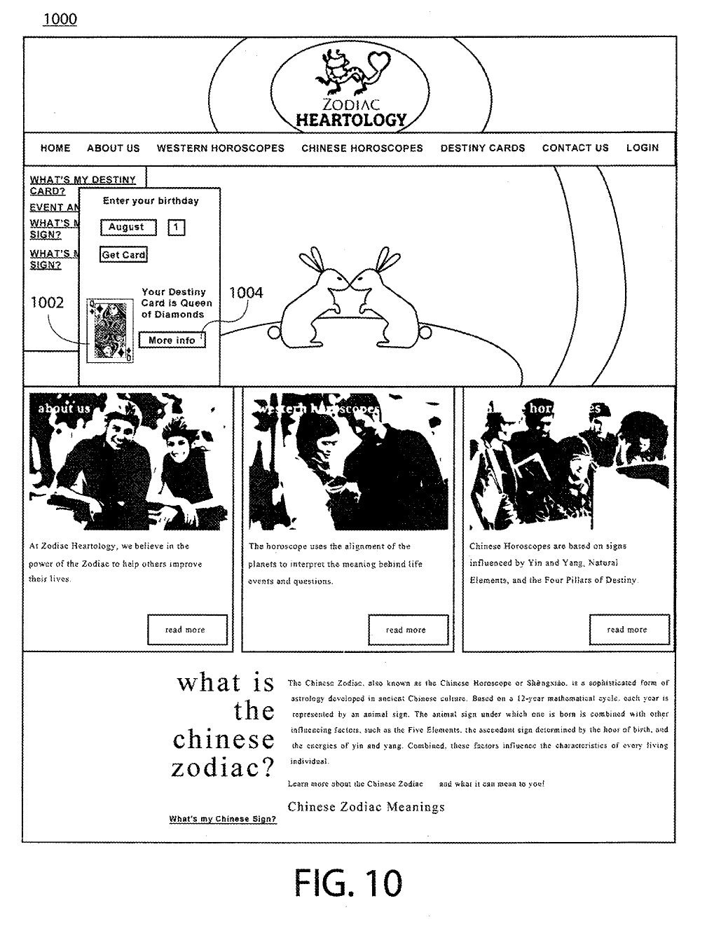

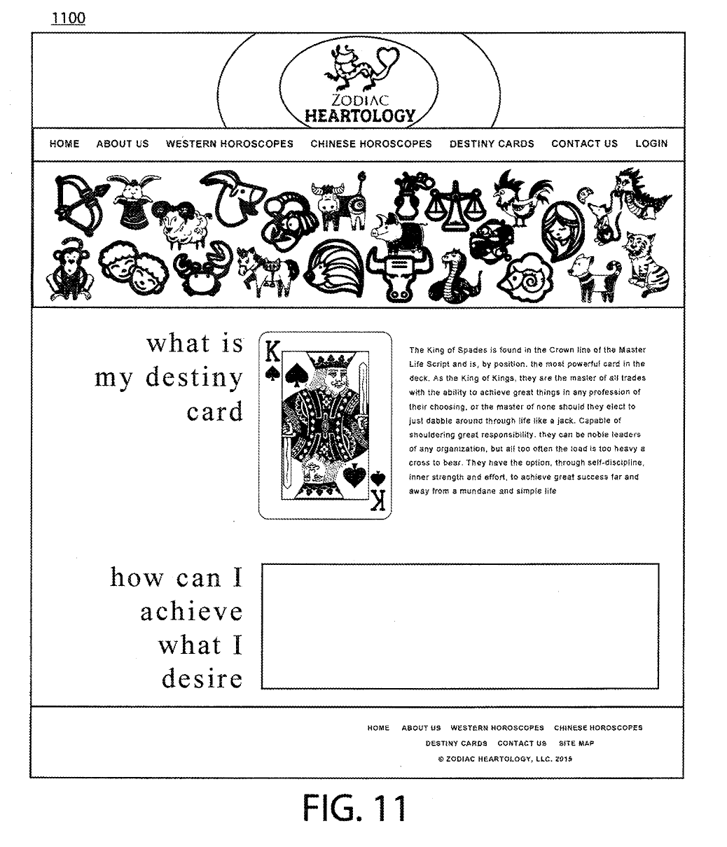

Further, from GUI 100, user can click on “What's my Destiny card” 118 and generate GUI 900 shown in FIG. 9, which generates a drop-down menu that allows the user to input his birth month and day, and click on button “Get Card” 902 to generate GUI 1000, shown FIG. 10. In this particular instance, for the birthdate January 1, the user's card, is displayed in box 802 as the King of Spades. Clicking on the “More info” button 1004 generates GUI 1100, shown FIG. 11. GUI 1100 provides a description of persons who are governed by the King of Spades, along with suggestions for how a person governed by the King of Spades can achieve what he/she desires.

If the user desires to register for the inventive system 50 in order to access additional features of the inventive system 50, the user can click on the “Login” button 114. “Login” button 114 can be accessed from any of GUI 200-1100 as well.

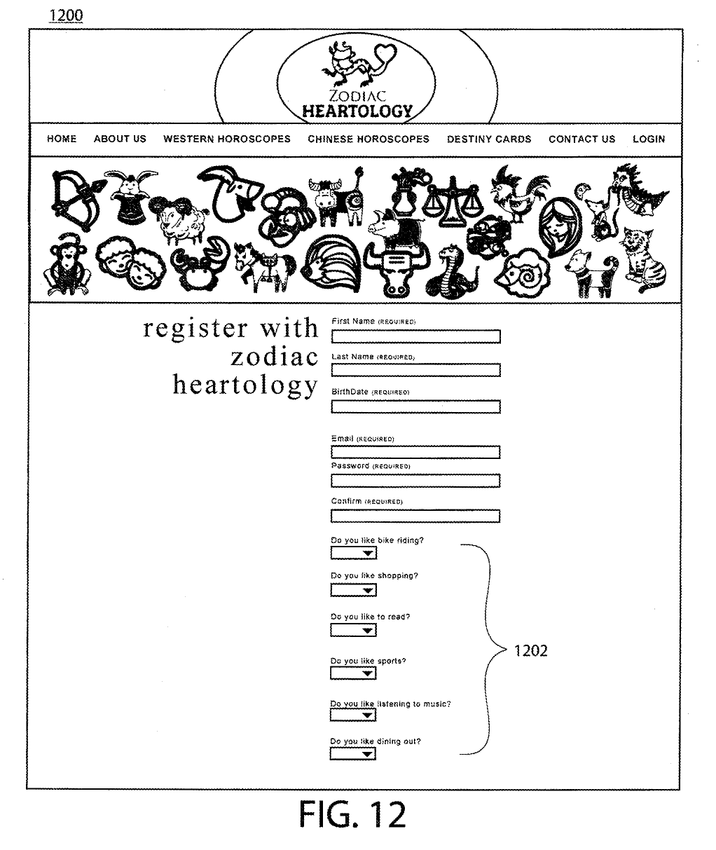

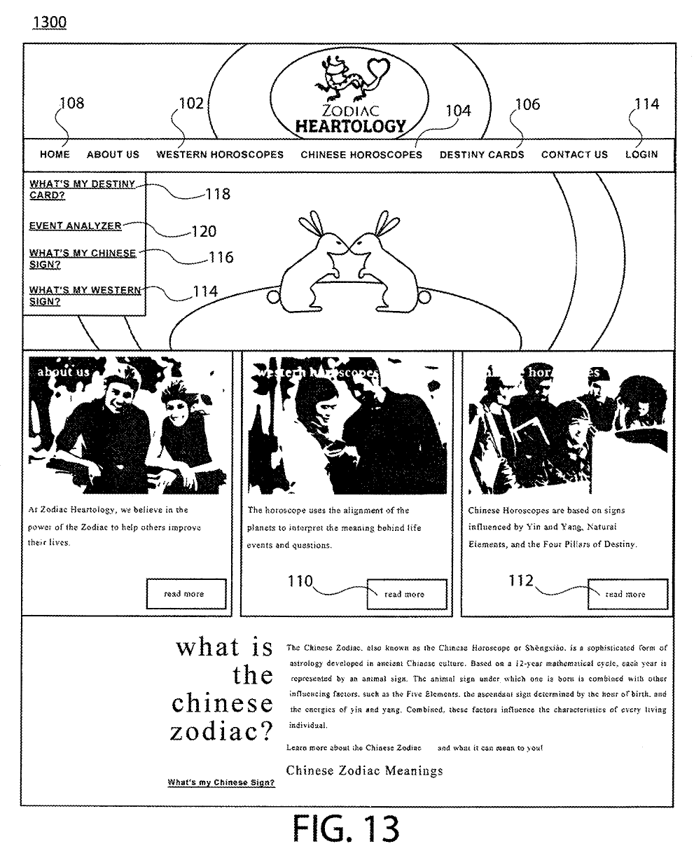

A new, unregistered user is requested to register with the system 50. To register with the system 50, new user, must provide information shown in GUI 1200, shown FIG. 12. In addition to personal information, such as name, birthdate, and e-mail address, user is asked to answer several questions 1202, the answers to which the system 50 uses in determining characteristic traits about the user. Upon successful registration, the user is directed to GUI 1300, shown FIG. 13, which allows the user to select different aspects of the present invention to determine individual characteristics, as well as potential compatibility information. In addition to the options available prior to logging in, as shown in GUI 100, shown FIG. 1A, a registered user can also access Event Analyzer 120, as well as other features that are available only to registered users.

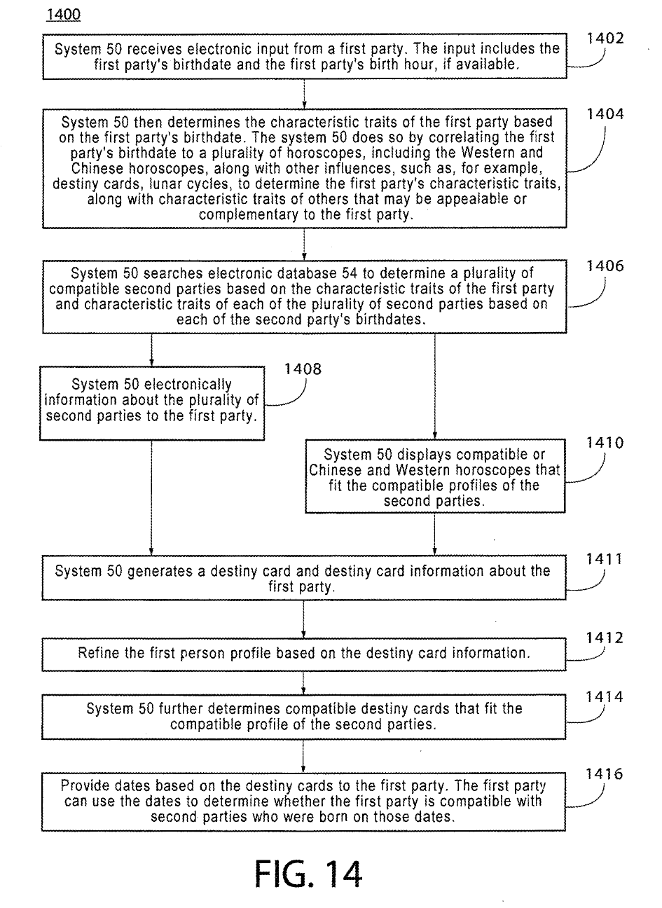

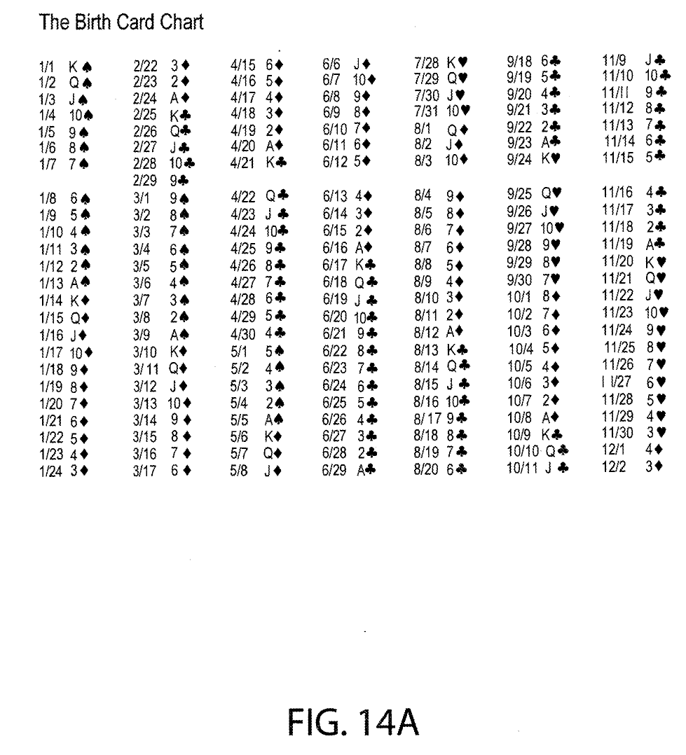

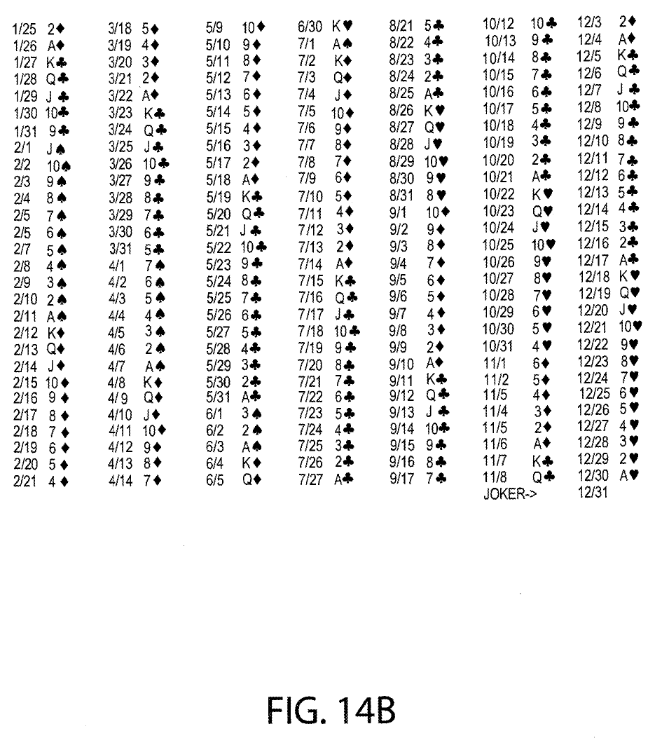

In addition to providing information to users about zodiacs and how zodiacs help the user to understand their characteristic traits, the present invention is also a system 50 and a method that can be used for electronically matching people, such as, for example, for potential dating relationships. Referring to flowchart 1400, shown FIG. 14, to electronically match people, in step 1402, system 50 receives electronic input from a first party. The input includes the first party's birthdate and the first party's birth hour, if available. In step 1404, system 50 then determines the characteristic traits of the first party based on the first party's birthdate. The system 50 does so by correlating the first party's birthdate to a plurality of horoscopes, including the Western and Chinese horoscopes, along with other influences, such as, for example, destiny cards, lunar cycles, to determine the first party's characteristic traits, along with characteristic traits of others that may be appealable or complementary to the first party. In step 1406, system 50 searches electronic database 54 to determine a plurality of compatible second parties based on the characteristic traits of the first party and characteristic traits of each of the plurality of second parties based on each of the second party's birthdates. In step 1408, system 50 electronically displays information about the plurality of second parties to the first party. Alternatively, in step 1410, instead of, or in addition to, system 50 electronically displaying information about the plurality of second parties, system 50 can display compatible or Chinese and Western horoscopes that fit the compatible profiles of the second parties.

Additionally, in step 1411, based on the first party's birthday, system 50 generates a destiny card and destiny card information about the first party, and, in step 1412, further refines the first person profile based on the destiny card information. In step 1414, system 50 further determines compatible destiny cards that fit the compatible profile of the second parties and, in step 1416, provide dates based on the destiny cards to the first party. The first party can use the dates to determine whether the first party is compatible with second parties who were born on those dates.

The Chinese horoscope includes the Chinese birth year, Yin/Yang, the Chinese elements of water, earth, fire, metal, and wood, as well as the calendar day. In step 1404, if the Western horoscope is in conflict with the Chinese horoscope, deference is given to the Chinese horoscope.

In addition to using zodiacs of horoscopes, system 50 also incorporates destiny cards as well as the “Four Personal Significators” to determine characteristics of the first party. The Four Personal Significators are the birth card, the spirit card, the planetary ruling card, and the soul card.

The birth card is determined by the month and day in which the party was born. This card represents the soul's expression. A chart of all 366 days of the year (including Leap Year) and their associated birth card is provided in FIG. 14A. This card's influence manifests as the party's distinguished signature to be expressed in the world. The essence of this card is embodied as an expression of self, and identify with it deeply. The party's lessons are embodied in this card.

The spirit card represents the inner environment and psyche, and what a party deals with inside of his/her own mind. This is an aspect of the party that wants to experience the fulfillment of self-expression. This card carries the party's challenges and opportunities, meaning that, when the party embraces and resolve those challenges that are specific to this card, they become that party's rewards.

The planetary ruling card is the card in your life path that corresponds with the ruling planet of your astrological sign. We identify with this influence on the mental level, and act out the characteristics of this card. This card is like an overlay of traits and characteristics in our personality, we often think that this is who we are. This card's Life Path has to do with our karmic journey, and represents how others see us.

The soul card embodies the gifts that that the first party brings into this life. This card shows that party how to manifest who it is that the party really is in essence, and it reveals the gifts that the party brings with him/her into this life. It reveals where the party has come from, and it is the representative of the soul's true essence and nature.

Further, in addition to the Four Personal Significators, Stars can also be incorporated to determine characteristics of a person. The stars are the Wealth Star, the Influence Star, the Resource Star, the Output Star, and the Friend Star.

The Wealth star governs business activities and entrepreneurial ideas. The wealth element is basically the element that one controls. Assuming your day master element is wood, then the element that wood controls-out to, ie. earth, is the wealth star of wood. So whenever the earth elements appear, those represent the wealth star.

The Influence star represents one's own discipline. The influence element is essentially the opposite of one's wealth element. This is the element that controls-in the day master. Assuming you are wood, then the elements that controls-in is metal. This is because metal chops wood. Therefore, metal is the influence star of wood.

The Resource star governs the act of studying and learning. If your personal element is water, then the resource star is the element that produces you ie, metal. Metal is your resource star.

The Output star represents performance such as singing, dancing and sports activities. If your personal element is fire, then the output element is earth. Earth is the output star of the fire day master.

The Friend star governs one's affinity with siblings, colleagues, friends, and also oneself the last of which is how one feels about him/herself ie. one's self-esteem, self-identity and confidence. The friend star also represents competitors and those within the same industry. The friend star is of the same element as one's personal element. So if you are a wood person, the other wood elements in your chart are friend stars.

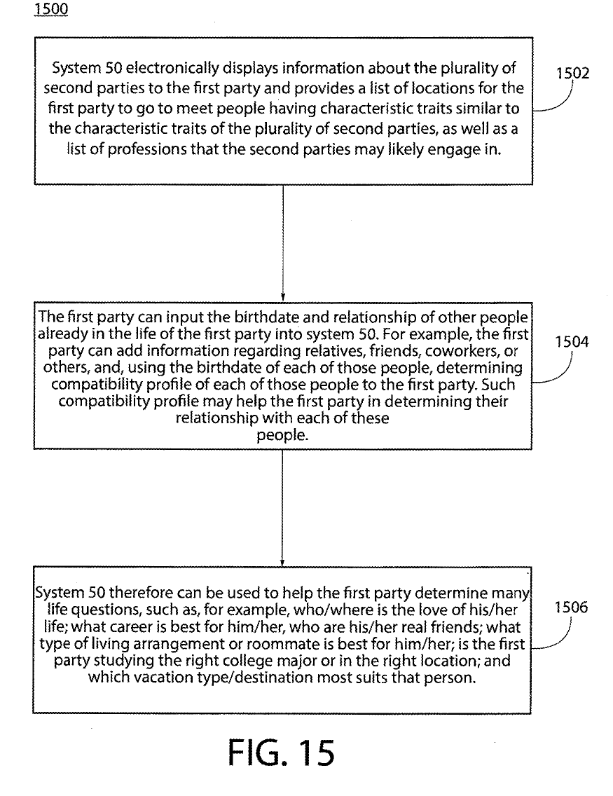

Referring to flowchart 1500, shown in FIG. 15, in step 1502, system 50 electronically displays information about the plurality of second parties to the first party. System 50 also provides a list of locations for the first party to go to meet people having characteristic traits similar to the characteristic traits of the plurality of second parties, as well as a list of professions that the second parties may likely engage in.

In addition to helping the first party in locating second parties for potential relationships, system 50 can be used to help the first party understand their areas of compatibility and incompatibility with others already in the life the first party. For example, in step 1504, the first party can input the birthdate and relationship of relatives, friends, coworkers, or others, and, using the birthdate of each of those people into system 50 and determine the compatibility profile of each of those people to the first party. Such compatibility profile may help the first party in understanding and guiding their relationship with each of these people. For example, system 50 can help determine compatibility with a significant other to help a person to determine whether he/she should continue with the relationship with the significant other.

In step 1506, system 50 therefore can be used to help the first party determine many life questions, such as, for example, who/where is the love of his/her life; what career is best for him/her, who are his/her real friends; what type of living arrangement or roommate is best for him/her; is the first party studying the right college major or in the right location; and which vacation type/destination most suits that person.

The present system 50 can be also used to categorize how well an athlete will likely perform athletically on a given day, such as, for example, the day during which the athlete is scheduled to compete. For example, the performance of the athlete may be categorized into one of several discrete phases, such as, “well”, “average”, and “poorly”.

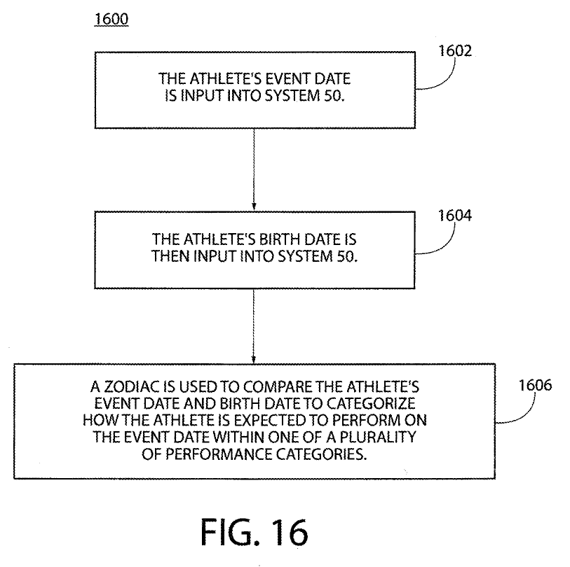

Referring to flowchart 1600, shown in FIG. 16, in step 1602, the athlete's event date is input into system 50. In step 1604, the athlete's birth date is then input into system 50. In step 1606, a zodiac is used to compare the athlete's event date and birth date to categorize how the athlete is expected to perform on the event date within one of a plurality of performance categories. In addition to using the zodiac to categorize the quality of the athlete's performance, destiny cards may be used as well.

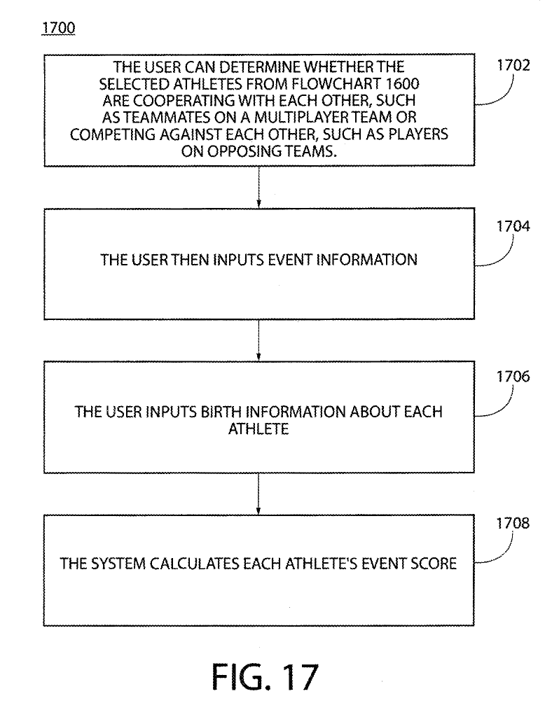

Referring to flowchart 1700, shown FIG. 17, in step 1702, the user can determine whether the selected athletes from flowchart 1600 are cooperating with each other, such as teammates on a multiplayer team or competing against each other, such as players on opposing teams. The user then inputs event information in step 1704. In step 1706, the user inputs birth information about each athlete and, in step 1708 calculates each athlete's event score.

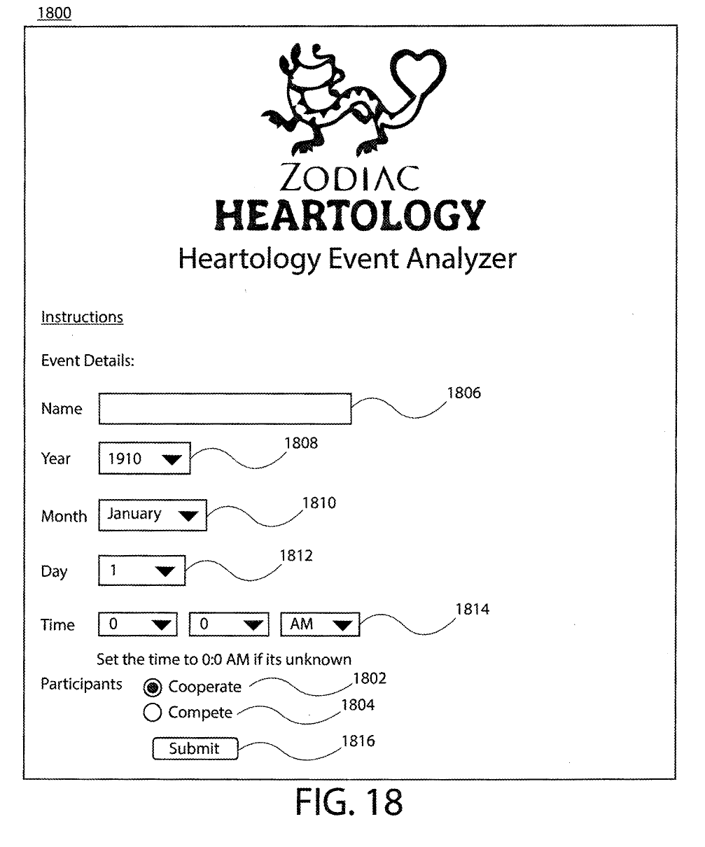

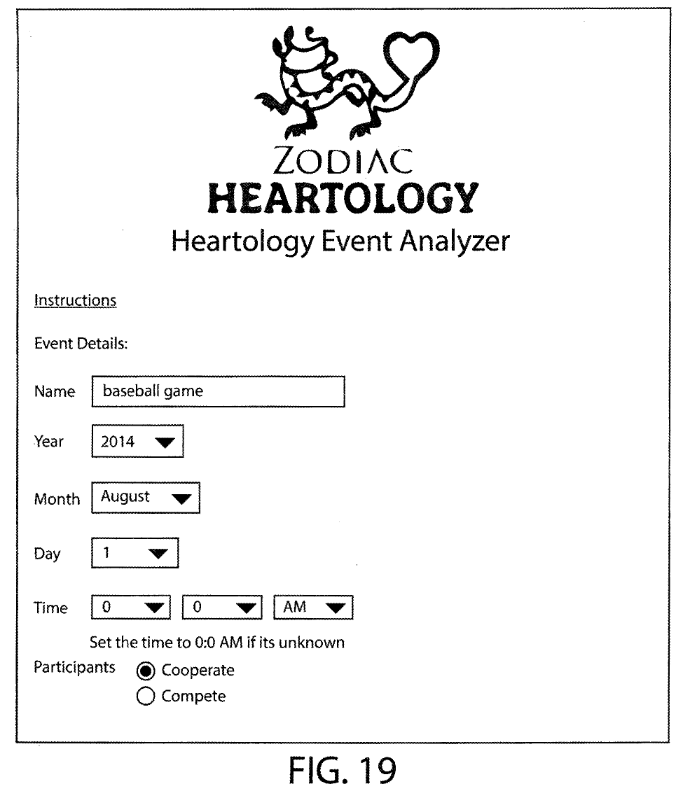

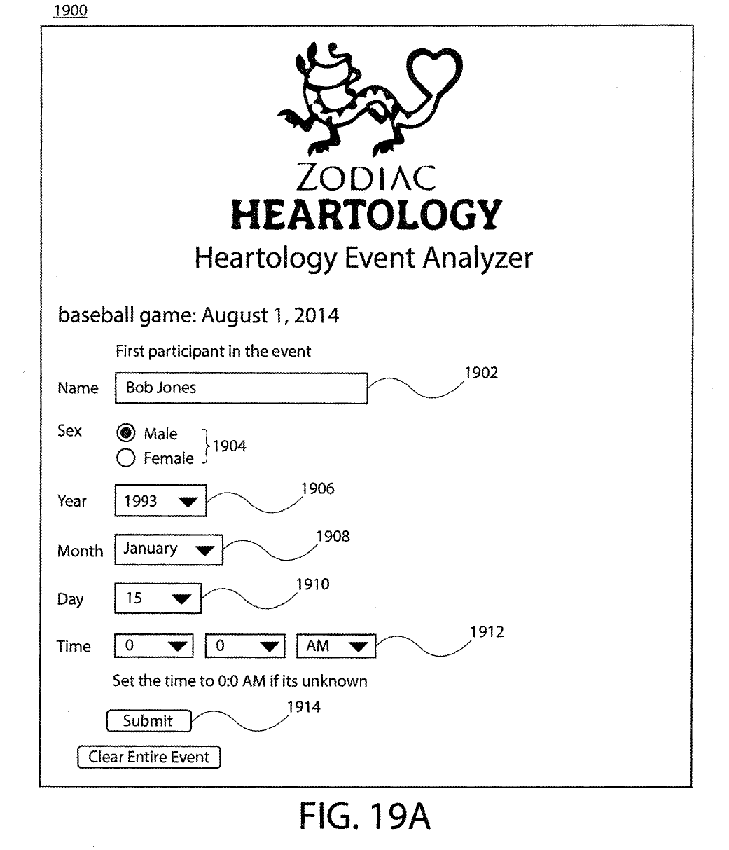

FIG. 18 is an exemplary screenshot 1800 of an event analyzer according to system 50 to categorize this how well athletes are expected to perform on a particular date in different types of athletic competitions. Screenshot 1800 is used by clicking on “Event Analyzer” button 120, shown in FIG. 13. For example, the athletes can cooperate with each other if they're on the same team, or they can compete against each other if they are on opposing teams. A user can click on “Cooperate” button 1802, or “Compete” button 1804 to select the type of event. Additionally, in blocks 1806-1814, the user can input the name, year, month, day, and time (if known) of the event. Clicking on button 1816 generates GUI 1900, shown FIG. 19.

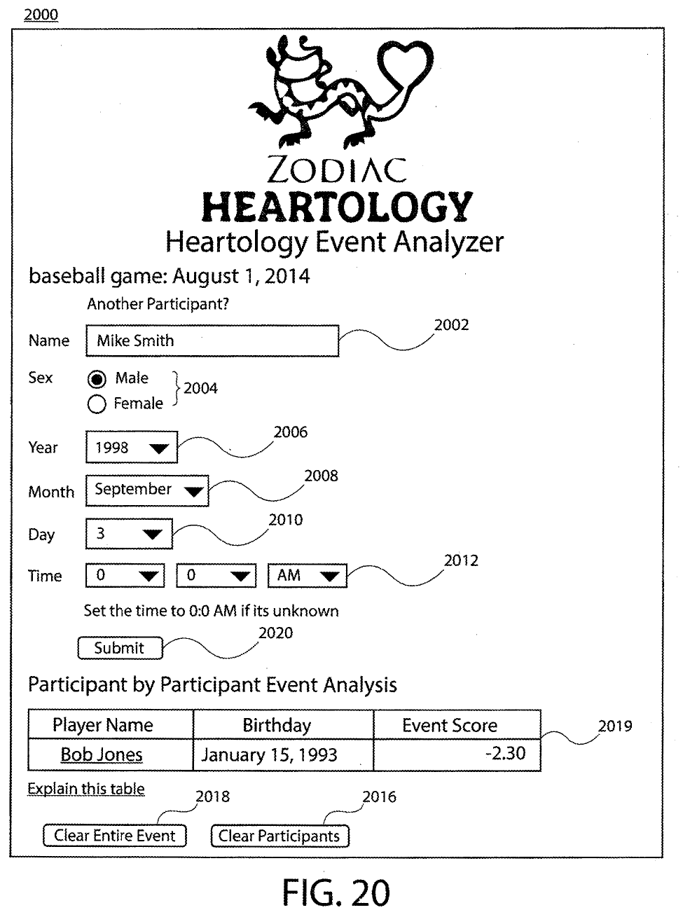

In FIG. 19, the event has already been listed as a baseball game to be played on Aug. 1, 2014. Boxes 1902-1912 allow the user to input the name, sex, and year, month, day, and time (if known) of birth of the participant. Clicking on “Submit” button 1914 generates GUI 2000, shown FIG. 20.

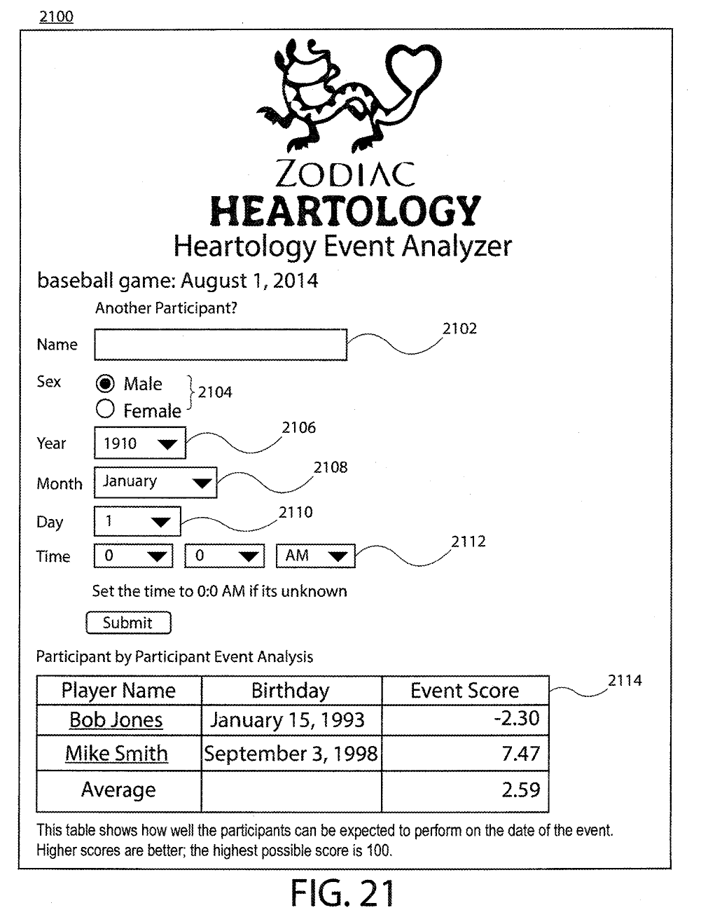

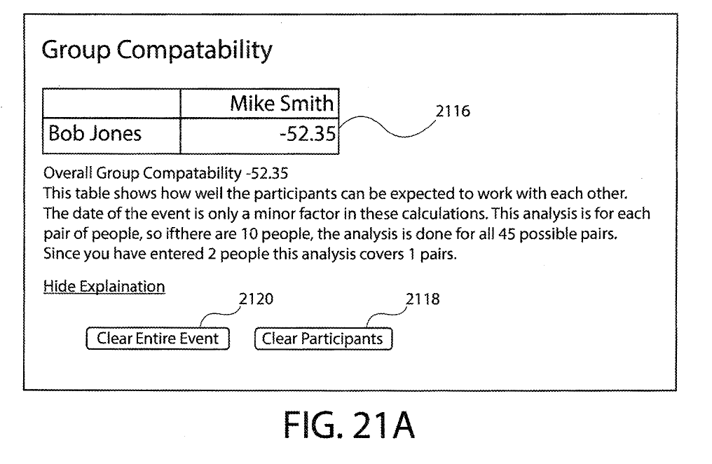

Similar to FIG. 19, in FIG. 20, and additional participant information is inputted into boxes 2002-2012. Additionally, all prior participants' information is displayed in table 2014. If the user desires to clear the participants, the user clicks on “Clear Participants” button 2016. Is user desires to clear the entire event, the user clicks on “Clear Entire Event” button 2018. When the user desires to calculate the athletes' event score, user clicks on “Submit” button 2020, which generates GUI 2100, shown in FIGS. 21 and 21A.

While allowing the user to input additional participant information in boxes 2102-2112, if desired, GUI 2100 also displays the scores for all of the athletic participants in table 2114. Table 2114 shows how well the participants can be expected to perform on the date of the event, with higher scores being better than lower scores, and the highest possible score being 100. FIG. 21A displays a “Group Compatibility” of the listed participants in table 2116, which shows how well the participants can be expected to work with each other. The date of the event is only a minor factor in these calculations. The analysis is for each pair of people, so if 10 people are included, the analysis is done for all 45 possible pairs of people. In the example shown FIG. 21A, only two participants are used, so the analysis only covers the single pair of participants. After the analysis is complete, the user can click on “Clear Participants” button 2118 to add new participants, or click on “Clear Entire Event” button 2120 to clear the event.

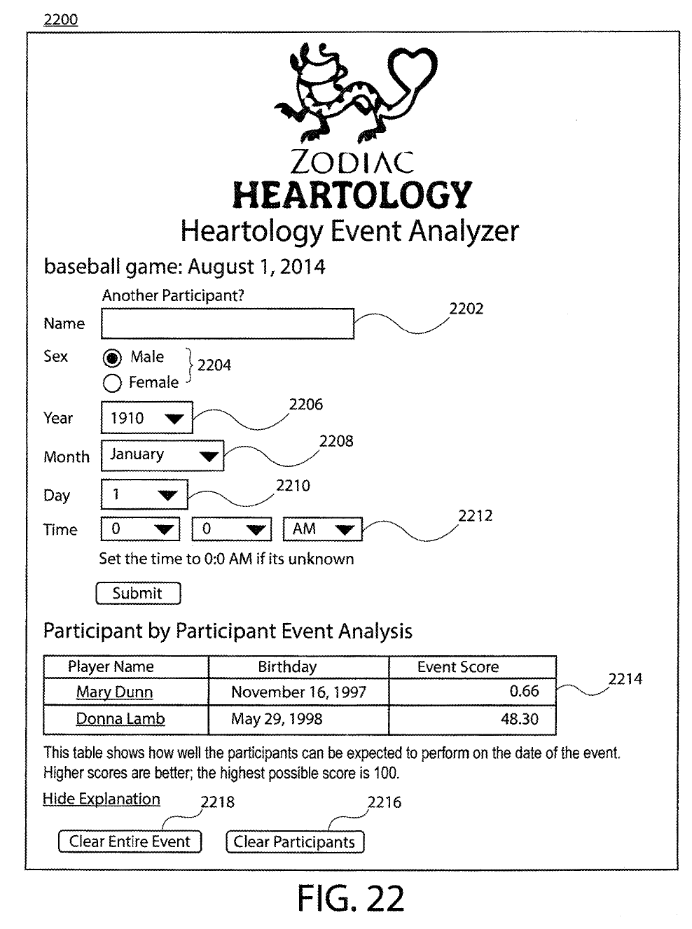

Referring back to FIG. 18, instead of clicking on “cooperate” button 1802, if user clicks on “Compete” button 1804, GUI 2200, shown in FIGS. 22-22A, is displayed. GUI 2200 includes blocks 2202-2210 to allow the user to input the name of the event, and the year, month, day, and time (if known) of the event. After the user has input the information into blocks 2202-2210, user clicks on “Submit” button 2212, which generates GUI 2200, shown in FIG. 22.

GUI 2200 allows the user to input participant information in blocks 2302-2312, which generates each participant's event score in table 2314. Table 2214 shows how well each participant can be expected to perform on the date of the event. Higher scores are better than lower scores, and the highest possible score is 100. After the analysis is complete, the user can click on “Clear Participants” button 2216 to add new participants or click on “Clear Event” button 2218 to clear the event.

By using system 50 to categorize how the athlete is expected to perform, a user can determine whether to use that athlete as part of a fantasy team, such as, for example, fantasy football, and elect whether to use the athlete if the athlete is categorized as being likely to play well that day, or “bench” the athlete in favor or another athlete if the athlete is categorized as being likely to play poorly that day.

Additionally, system 50 can be used to determine how other athletes in individual sports, such as for example, tennis players, boxers, or race car drivers, are expected to perform at a given event based on their zodiac. Additionally, system 50 can be used to compare political candidates, as well as to provide recommended dates for a person to play the lottery.

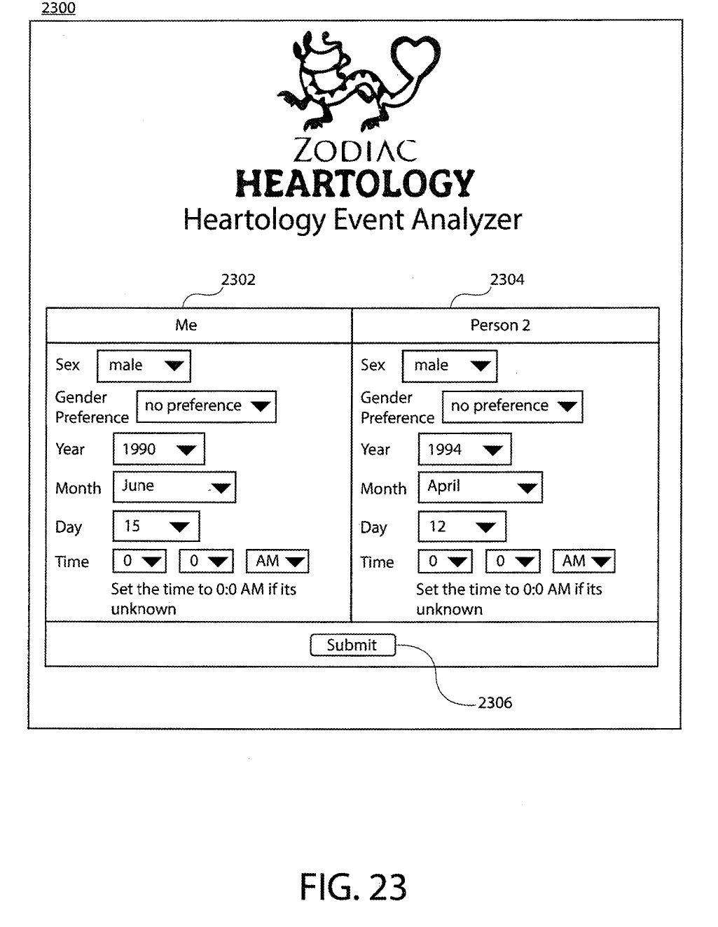

A BaZi Compatibility Calculator, shown in FIG. 23, can be used to determine the compatibility between two people. The user inputs, gender, gender preference, and birth information of the first-person, such as, the user, in the appropriate box in column 2302 and then inputs, gender, gender preference, and birth information about a second person in the appropriate box in column 2304 and then presses “Submit” button 2306. A compatibility algorithm determines the compatibility between the two people using zodiac information.

An exemplary Compatability Algorithm according to the present invention is shown below.

1. Input the following information:

a. birth date and time of 2 people

b. gender of each person

c. gender preference of each person

d. call the people A and B.

2. If gender and gender preferences are not compatible, STOP, return −100.

3. For each person, make standard BaZi calculation to determine “Stem” and “Branch” for Year, Month, Day, Hour, and current 10 year luck pillar.

a. Call these values: aYearStem, aMonthStem, aDayStem, aTimeStem, aLuckStem and aYearBranch, aMonthBranch, aDayBranch, aTimeBranch, aLuckBranch.

b. Apply similar names for person B, but with a prefix “b” instead of “a”.

c. Stem is 1 of 10: Yin Water, Yang Water, Yin Fire, etc.

d. Branch is 1 of 12: Rooster, Dog, Pig, Rat, etc.

Exemplary BaZi calculations for persons A and B are shown below.

Person A

| Period | Branch | Stem |
|---|---|---|
| Year | Yin Water | Rabbit |
| Month | Yang Fire | Dog |
| Day | Yin Earth | Pig |
| Time | Yang Water | Rooster |
| Luck | Yang Earth | Dog |

Person B

| Period | Branch | Stem |
|---|---|---|
| Year | Yang Water | Rabbit |
| Month | Yang Earth | Snake |
| Day | Yin Earth | Dragon |
| Time | Yang Fire | Dragon |
| Luck | Yin Metal | Dog |

Next, Bazi calculations for persons A and B are matched by period (year, month) and type (stem, branch). The compatibility for each matched pair is evaluated into values between “−1” (most incompatible) to “1” (most compatible, with “0” being neutral. Exemplary matches are shown below.

| Period | Person A | Person B | Value |
|---|---|---|---|
| Year | Yin Water | Yang Water | 1 |
| Month | Yang Fire | Yang Earth | 0 |
| Day | Yin Earth | Yin Earth | −1 |
| Time | Yang Water | Yang Fire | −1 |
| Luck | Yang Earth | Yin Metal | 1 |

| Period | Person A | Person B | Value |
|---|---|---|---|
| Year | Rabbit | Rabbit | 0 |
| Month | Dog | Snake | 1 |
| Day | Pig | Dragon | −1 |
| Time | Rooster | Dragon | 1 |
| Luck | Dog | Dog | 1 |

3. Based on Standard BaZi Principles, form 2 compatibility matrices.

A 10 by 10 matrix shows compatibility among stems. The entries in the matrix are 1 if the two stems are highly compatible, −1 if the two stems are highly incompatible, and 0 if the two stems are neutral with respect to each other. Decimals (e.g. 0.5) are allowed to indicate a modest compatibility. The compatibility is determined by known charts showing how elements relate to other elements and how animals relate to other animals in the Chinese zodiac.

In the matrix below, each row represents a particular Bazi stem. Similarly, each column represents a Bazi stem. For example, if row 1 is for “Yin Earth” and column 5 is for “Yang Fire” then the entry at row 1, column 5 shows the compatibility between Yin Earth and Yang Fire. In the table below, the value is −0.33, which shows a modest incompatibility. The values can span between −1.00 and 1.00 in increments of about 0.17 to reflect varying degrees of compatibility or incompatibility.

| | | | | | | | | | |
|---|---|---|---|---|---|---|---|---|---|
| 0.33 | 0.33 | −0.17 | 0.50 | −0.33 | 0.33 | −0.67 | 0.17 | −0.17 | 0.00 |
| 0.33 | 0.00 | 0.00 | 0.00 | −0.17 | −0.17 | 0.17 | −0.50 | 0.50 | −0.67 |
| −0.17 | 0.00 | −0.33 | 0.33 | −0.17 | 0.33 | −0.17 | 0.50 | 0.00 | 0.17 |
| 0.50 | 0.00 | 0.33 | 0.17 | 0.17 | −0.33 | 0.00 | −0.67 | 0.17 | −1.00 |
| −0.33 | −0.17 | −0.17 | 0.17 | 0.00 | 0.00 | 0.17 | 0.00 | 0.00 | 0.17 |
| 0.33 | −0.17 | 0.33 | −0.33 | 0.00 | −0.50 | 0.17 | −0.33 | 0.17 | −0.67 |
| −0.67 | 0.17 | −0.17 | 0.00 | 0.17 | 0.17 | 0.33 | 0.33 | −0.17 | 0.50 |
| 0.17 | −0.50 | 0.50 | −0.67 | 0.00 | −0.33 | 0.33 | −0.33 | 0.00 | −0.17 |
| −0.17 | 0.50 | 0.00 | 0.17 | 0.00 | 0.17 | −0.17 | 0.00 | −0.33 | 0.33 |
| 0.00 | −0.67 | 0.17 | −1.00 | 0.17 | −0.67 | 0.50 | −0.17 | 0.33 | 0.33 |

Call this cStem.

A 12 by 12 matrix shows compatibility among branches. The entries in the matrix are 1 if the two branches are highly compatible, −1 if the two stems are highly incompatible, and 0 if the two branches are neutral with respect to each other. Decimals (e.g. 0.5) are allowed to indicate a modest compatibility. The compatibility is determined by known charts showing how elements relate to other elements and how animals relate to other animals in the Chinese zodiac.

The matrix is symmetric about the main diagonal. An exemplary matrix is shown below.

| | | | | | | | | | | | |
|---|---|---|---|---|---|---|---|---|---|---|---|
| 0 | 0 | 0 | −1 | 1 | −1 | −1 | 0 | 1 | −1 | 0 | 1 |
| 0 | 0 | 0 | 0 | −1 | 1 | 0 | −1 | 0 | 1 | 1 | 0 |
| 0 | 0 | 0 | −1 | 0 | −1 | 1 | 0 | −1 | 1 | 1 | −1 |
| −1 | 0 | −1 | 0 | 0 | 0 | 0 | 1 | 1 | −1 | 0 | 1 |
| 1 | −1 | 0 | 0 | 0 | 0 | 0 | 1 | 1 | 0 | −1 | 0 |
| −1 | 1 | −1 | 0 | 0 | −1 | 1 | 0 | 0 | 1 | 0 | −1 |
| −1 | 0 | 1 | 0 | 0 | 1 | 0 | 0 | 0 | −1 | 1 | −1 |
| 0 | −1 | 0 | 1 | 1 | 0 | 0 | 0 | 0 | 0 | −1 | 1 |
| 1 | 0 | −1 | 1 | 1 | 0 | 0 | 0 | 0 | −1 | 0 | −1 |
| −1 | 1 | 1 | −1 | 0 | 1 | −1 | 0 | −1 | 0 | 0 | 0 |
| 0 | 1 | 1 | 0 | −1 | 0 | 1 | −1 | 0 | 0 | 0 | 0 |
| 1 | 0 | −1 | 1 | 0 | −1 | −1 | 1 | −1 | 0 | 0 | 0 |

Call this cBranch.

4. Based on Standard BaZi principles, choose weights for each of Year, Month, Day, Time and Luck. Exemplary values are Year: 5; Month: 15; Date: 10; Time: 12; Luck: 8. Call these weights wYear, wMonth, wDay, wTime and wLuck, respectively. The sum of these weights should be 50.

5. Set sum=0.

6. For each period in {Year, Month, Day, Time and Luck} and for each Type in {Stem, Branch} sum=sum+wPeriod*cType[aPeriodType][bPeriodType]. For example, the values above yield the exemplary weighted values in the matrix below.

| Period | Value | Weight | Weighted value |
|---|---|---|---|
| Year | 1 | 5 | 5 |
| Month | 0 | 15 | 0 |
| Day | −1 | 10 | −1- |
| Time | −1 | 12 | −12 |
| Luck | 1 | 8 | 8 |
| Year | 0 | 5 | 5 |
| Month | 1 | 15 | 15 |
| Day | −1 | 10 | −10 |
| Time | 1 | 12 | 12 |
| Luck | 1 | 8 | 8 |

7. The result of step 6 is a number between −100 and 100. A score of −100 means total incompatibility; a score of 100 means total compatibility; and a score of 0 means neutral compatibility.

Finally, take the sum of the “weighted value” column (steps 5-7), which is 16. This is the compatibility value for these two people A and B, and is shown on the graph 2400 in FIG. 24. Graph 2400 is a bell curve 2402 that shows a greater percentage of persons having compatibility ratings between about −25 and 25, with a “0” score being neutral. In the example shown in FIG. 24, a score of −1 was generated using the calculations above, indicating a very slight incompatibility between persons A and B. Additionally, graph 2400 indicates that about 46% of all possible relationships have a worse score (and about 54% of all relationships have a better score).

Similar types of calculations can be performed for other types of horoscopes. For example, known relationships of the Western horoscope characters can be used instead of the Chinese/Bazi relationships described above. Once all of the horoscope calculations are performed, relative values are assessed to each horoscope. For example, it is described above that the Western horoscope defers to the Chinese horoscope when the two horoscopes are in conflict.

It is understood that various changes in the details, materials, and arrangements of the parts which have been described and illustrated in order to explain the nature of this invention may be made by those skilled in the art without departing from the scope of the invention as expressed in the following claims.

What is claimed is:

1. A method for matching people, the method comprising:
a. receiving electronic input from a first party, the input including the first party's birthdate;
b. determining characteristic traits of the first party based on the first party's birthdate;
c. searching an electronic database to determine a plurality of compatible second parties based on the characteristic traits of the first party and characteristic traits of each of the plurality of second parties based on each of the second party's birthdates; and
d. electronically displaying information about the plurality of second parties to the first party.

2. The method according to claim 1, wherein step b. comprises using a combination of Chinese horoscope, Western horoscope, lunar cycles, and destiny cards to determine the characteristic traits.

3. The method according to claim 2, wherein, when the Chinese horoscope and the Western horoscope provide conflicting traits, providing deference to the Chinese horoscope.

4. The method according to claim 2, wherein the Chinese horoscope includes the Chinese birth year, the Yin and the Yang, Chinese elements, and the calendar day.

5. The method according to claim 2, further comprising determining compatible destiny cards that fit the compatible profile, and providing dates based on the destiny cards to the first party.

6. The method according to claim 1, further comprising providing a list of locations for the first party to go to meet people having characteristic traits similar to the characteristic traits of the second parties.

7. The method according to claim 1, wherein step d. further comprises providing a list of professions that the second parties may likely engage in.

8. The method according to claim 1, wherein the input comprises the first party's birth hour.

9. The method according to claim 1, wherein the parties comprise athletes competing against each other.

10. A non-transitory machine-readable storage medium, having encoded thereon program code, wherein, when the program code is executed by a machine, the machine implements a method for matching people, the method comprising:
a. receiving electronic input from a first party, the input including the first party's birthdate;
b. determining characteristic traits of the first party based on the first party's birthdate;
c. searching an electronic database to determine a plurality of compatible second parties based on the characteristic traits of the first party and characteristic traits of each of the plurality of second parties based on each of the second party's birthdates; and
d. electronically displaying information about the plurality of second parties to the first party.

11. The non-transitory machine-readable storage medium according to claim 10, wherein the medium comprises:
a. a receiving interface adapted to receive personal information from a first party, the personal information including a first birthdate;
b. a database including characteristic traits of people having the first birthdate, the characteristic traits including at least one trait selected from the group consisting of: employment and leisure activities;
c. a processor configured to determine characteristic traits of other parties that are compatible with the characteristic traits of people having the first birthdate; and
d. a transmitting interface adapted to transmit information about the other parties to the first party.
